(19) United States
(12) Patent Application Publication
(10) Pub. No.: US 2005/0021467 A1
(43) Pub. Date: Jan. 27, 2005

(54) Distributed digital rights network (drn), and methods to access operate and implement the same

(76) Inventor: Robert Franzdonk, Vista, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/489,132

(22) PCT Filed: Sep. 7, 2001
(86) PCT No.: PCT/US01/27712

(51) Int. Cl. G06F 17/60

(52) U.S. Cl. 705/51

(57) ABSTRACT

A digital rights network (10) includes a digital rights server (36) to store content consumer rights, defining access right of a content consumer with respect to content, and content owner rights defining access policies to the content as established by a content owner. A digital rights agent (28) is to perform cryptographic operations with respect to access operations relating to the content consumer rights and the content owner rights. The access operations include a first access operation with respect to the content consumer rights and a second access operation with respect to the content owner rights. The access operations relating to the content consumer rights and the content owner rights may be performed by anyone of a plurality of users of the digital rights network such as the content owner, a commerce service provider (42), a content distributor (20) and the content consumer. The commerce service provider (42) may be a customer relationship management operator.

### FIELD OF THE INVENTION

The present invention relates generally to the field of network communications and, more specifically, to methods and systems for the secure distribution and delivery of content via a communications network.

### BACKGROUND OF THE INVENTION

The proliferation of networks, and the widespread acceptance of the Internet as a communication and distribution channel in particular, have presented a number of opportunities for pay media content distribution. Specifically, broadband Internet Protocol (IP) networking has provided a number of new opportunities for publishing and media content distribution worldwide. The ability of networks to support resource-intensive media, such as streaming media multicasting, is growing rapidly as broadband IP technologies allow content and service providers to distribute high-quality video to millions of subscribers simultaneously.

However, these opportunities have been accompanied by concerns regarding content piracy and digital rights management (DRM). A challenge facing traditional pay media distributors is to enable content providers to control their proprietary content, while maintaining the flexibility to distribute media content widely. The increased distribution potential heightens the need to protect and secure media content. For example, a content provider may have particular concerns regarding preventative measures to minimize the possibility of premium content falling into wrong hands, and the enforcement of copyrights.

Conditional Access (CA) technology for traditional broadcasting systems is based on implementing business rules in a secure device (e.g., a smart card) located at the subscriber receiving device. Access to content is controlled by encrypting the content with a key. The secure device will only release this key to the decrypting device if the subscriber fulfills the access conditions set by an operator. A problem with such security systems is that the secure devices in the field need to be replaced when new business rules are introduced or when the security system is ‘hacked’. When a large number of secure devices in the field need to be updated, it will be appreciated that the cost implications are significant.

The Internet is becoming a platform for content delivery to millions of users worldwide. Using the Internet for secure content delivery introduces several problems. For example, standard Client/Server systems often cannot handle the load associated with large pay-per-view events, as a single central security server is typically not equipped to handle millions of events in a short time period. Further, standard Client/Server systems typically require that all users share a single content encryption key, rendering such systems vulnerable to key hook piracy (extracting the key and distributing the key to unauthorized users). Distributed security systems to manage access to content (e.g., LDAP) partially address the first problem identified above, but do not protect the content encryption keys from unauthorized operators.

A rapidly growing broadband Internet audience is making the Internet an exciting place to stream audio and video directly to millions of users worldwide. To overcome Internet congestion, streaming media may be pushed to the edges of the Internet (e.g., to the ISP's), where it is cached and from where the media can be streamed at high quality to the end user. Content providers (or owners) are increasingly using the Internet as a platform to deliver high quality programming to a large and rapidly growing audience. However, content providers are often reluctant to put premium content on the Internet, as digital content can easily be stored, forwarded and copied without any degradation by any user with a computer and a (broadband) Internet connection. Copy protection standards, such as those specified by 5C, at the end user device using a physical secure device for decryption are expensive and somewhat unsafe. An experienced hacker can typically break into the secure device and retrieve the decrypted content and redistribute the content anonymously or, in a worst-case scenario, retrieve a decryption key and redistribute the content anonymously.

When a content provider wants to secure and sell premium content for distribution over a large worldwide network, such as the Internet, there are a number of functions and systems that may need to be installed for a successful implementation. For example, secure storage and distribution of content encryption (or product) keys may be required to prevent exposure of the content (or product) encryption keys to a fraudulent operator or user. The exposure of such content encryption keys may result in a significant loss of revenue because of piracy. Further, a secure and scaleable key distribution system, which can manage a large number of subscribers simultaneously, may need to be in place. A scalable key distribution system may become critical to distribute content associated with large-scale live events. The implementation and operational costs associated with system software and hardware required to implement these functions may be high for a single content provider.

### SUMMARY OF THE INVENTION

According to one aspect of the present invention, there is provided a digital rights network including digital rights server to store content consumer rights, defining access rights of a content consumer with respect to content, and content owner rights defining access policies to the content as established by a content owner. A digital rights agent is to perform cryptographic operations with respect to access operations relating to the content consumer rights and the content owner rights. The access operations include a first access operation with respect to the content consumer rights and a second access operation with respect to the content owner rights.

The access operations relating to the content consumer rights and the content owner rights may be performed by any one of a plurality of users of the digital rights network.

In one embodiment, the plurality of users of the digital rights network include the content owner, a commerce service provider, a content distributor and the content consumer. The commerce service provider may be a customer relationship management (CRM) operator.

The digital rights network may include plurality of digital rights agents, and the access operations may be performed through at least one of the plurality of digital rights agents.

In one embodiment, the plurality of digital rights agents is distributed across a communications network.

The first access operation may be performed by a content distributor with which the content consumer has a relationship.

Alternatively, the first access operation may be performed by a commerce service provider with which the content consumer has a relationship.

The second access operation may be performed by the content owner.

The access operations may include, for example, any one of a rights query, a rights update, a rights registration, a rights de-registration and a rights exercise operation.

The first and the second access operations are, in one embodiment, both performed through the digital rights agent.

The cryptographic operations may include any one of identity authentication, license creation, data encryption, data description, signature generation and signature verification.

The identity authentication may be performed utilizing any one of a digital signature, username/password and TLS/SSL-based authentication.

In one embodiment, a distributed set of the digital rights servers is to the content consumer rights and the content owner rights.

The digital rights server may be to store and retrieve the content consumer rights and the content owner rights, and the digital rights agent may be to enforce the content consumer rights and the content owner rights.

The content consumer rights are possibly acquired from a content distributor with which the content consumer has a relationship. The content consumer rights may also acquired from a plurality of network operators. A certificate may be associated with the content consumer, and the content consumer rights, acquired from the plurality of network operators, may be attributed to the content consumer utilizing the certificate.

In one embodiment, the first access operation is to register the content consumer and is performed by a network operator, the digital rights agent to verify that the network operator is authorized to perform the first access operation.

The first access operation may also be to register the content consumer rights, and the digital rights agent may operate to encrypt and sign the content consumer rights prior to storage thereof by the digital rights server.

The first access operation may be by the content consumer and to create a license to the content, wherein the digital rights agent may operate to create the license.

The first access operation may be by the content consumer to validate access to the content, and the digital rights agent may operate to perform the validating action.

In one embodiment, digital rights server comprises a content server to store the content owner rights and a user server to store the content consumer rights.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a diagrammatic representation of a content distribution system 10, within which the present invention may be deployed

FIG. 2 is a block diagram illustrating further details regarding software components that may reside at various locations of the content distribution system to facilitate distribution and delivery processes.

FIG. 3 is a block diagram illustrating further architectural details regarding an exemplary embodiment of a content distribution system.

FIG. 4 is a diagrammatic representation of an exemplary deployment of the digital rights network, according to one embodiment of the present invention, and illustrates the interactions of a content provider, a content distributor, a commerce service provider and a content destination with the components of the digital rights network.

FIG. 5 is a flowchart illustrating a method, according to an exemplary embodiment of the present invention, of operating a digital rights network, where a plurality of digital rights agent act as gatekeepers for all access operations relating to the digital rights network by all users of the digital rights network.

FIG. 6 is a flowchart illustrating a method, according to an exemplary embodiment of the present invention, of performing content registration and protection operation.

FIG. 7 is a flowchart illustrating a method, according to an exemplary embodiment of the present invention, of facilitating a content ordering operation.

FIG. 8 illustrates the exemplary digital rights network utilizing XML, HTTP, HTTPS and LDAP for all of internal and external interfaces.

FIG. 9 illustrates an exemplary manner in which users of the digital rights network may access to the digital rights network utilizing content management systems, to perform content policy management, and user management systems, to perform user rights management

FIG. 10 illustrates the digital rights network, in one embodiment, providing a number of interfaces for accessing, protecting, monetizing and tracking content.

FIG. 11 illustrates the digital rights network of providing an interface for effective and secure user/account management.

FIG. 12 illustrates the digital rights network of providing a number of default applications for a CRM operator:

FIG. 13 is a block diagram illustrating a machine, in an exemplary form of a computer system, which may operate to execute a sequence of instructions, stored on a machine-readable medium, for causing the machine to perform any of the methodologies discussed in the present specification.

### DETAILED DESCRIPTION

A digital rights network (DRN), and methods of operating and implementing the same, is described. In the following description, for purposes of explanation, numerous specific details are set forth in order to provide a thorough understanding of the present invention. It will be evident, however, to one skilled in the art that the present invention may be practiced without these specific details and that these specific details are exemplary.

Overview—Content Distribution System

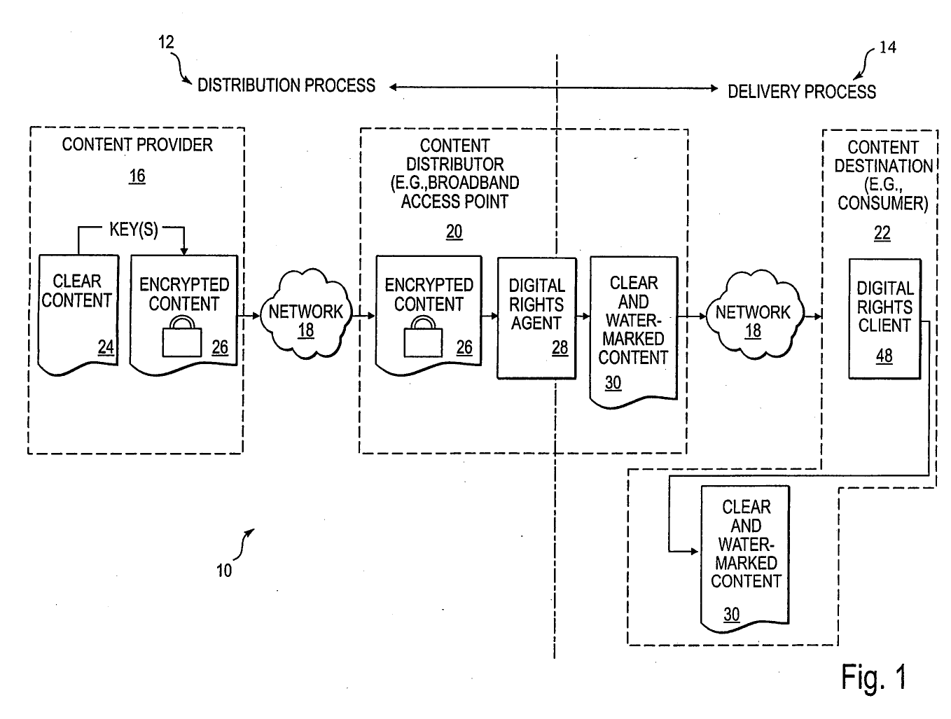

FIG. 1 is a diagrammatic representation of a content distribution system 10, within which the present invention may be deployed. The system 10 may conceptually be viewed as comprising a distribution process 12 and a delivery process 14. Within the distribution process 12, multiple content providers 16 (e.g., a content producer or owner) distribute content via a network 18 (e.g., the Internet (wireless or wired)) to content distributors (or distribution points) 20. The distribution of content from a content provider 16 to a content distributor 20 may be as a multicast via satellite, as this provides an economic way to distribute content to a large number of content distributors 20.

Each of the content distributors 20 caches content received from multiple content providers 16, and thus assists with the temporary storage of content near the “edges” of a network so as to reduce network congestion that would otherwise occur were a content provider 16 to distribute content responsive to every content request received from a content consumer. Each content distributor 20 is equipped to respond to requests received via the network 18 from the multiple content destinations 22 (e.g., subscribers or other types of content consumers) within a specified service area or conforming to specific criteria. Specifically, a content distributor 20, after performing the necessary authorization and verification procedures, may forward content that it has cached to a content destination 22 or, if such content has not been cached, may issue a request for the relevant content to a content provider 16. For example, if the content comprises a live “broadcast”, the content may be directly forwarded via the content distributor 20 to the content destination 22.

Typically, a request for content from a content destination 22 is re-routed to a content distributor 20 located nearby the requesting content destination 22. The requested content is then streamed (or otherwise transmitted) from the content distributor 20 to a media terminal (e.g., a personal computer (PC), set-top box (STB), a mobile telephone, a game console, etc.) at the content destination 22.

FIG. 1 illustrates, at a high-level, the processing of content as it is communicated from a content provider 16, via a content distributor 20, to a content destination 22. At the content provider 16, clear content 24 is encrypted utilizing, for example, a symmetric product key (or content key) to generate encrypted content 26. It will thus be appreciated that the content provider 16 will be particularly concerned about security pertaining to the product key as access to this key potentially allows for regeneration of the clear content 24. The encrypted content 26 (or cipher text) is then communicated from the content provider 16, via the network 18, to the content distributor 20. A digital rights agent 28, which represents the interests of the content provider 16, may perform a number of operations in a secure environment with respect to the encrypted content 26. In one embodiment, the digital rights agent 28 decrypts the encrypted content 26 to regenerate the clear content 24 within a secure environment, and watermarks the clear content for distribution to a specific content destination 22. Watermarked content 30 may then be distributed from the content distributor 20 via the network 18, to a digital rights client 48 at the content destination 22. In an alternative embodiment, the digital rights agent 28 at the content distributor 20 may re-encrypt the content with a public key of a copy-protected device at the content destination 22. In any event, the clear and watermarked content 30 is then available for viewing and consumption at the content destination 22.

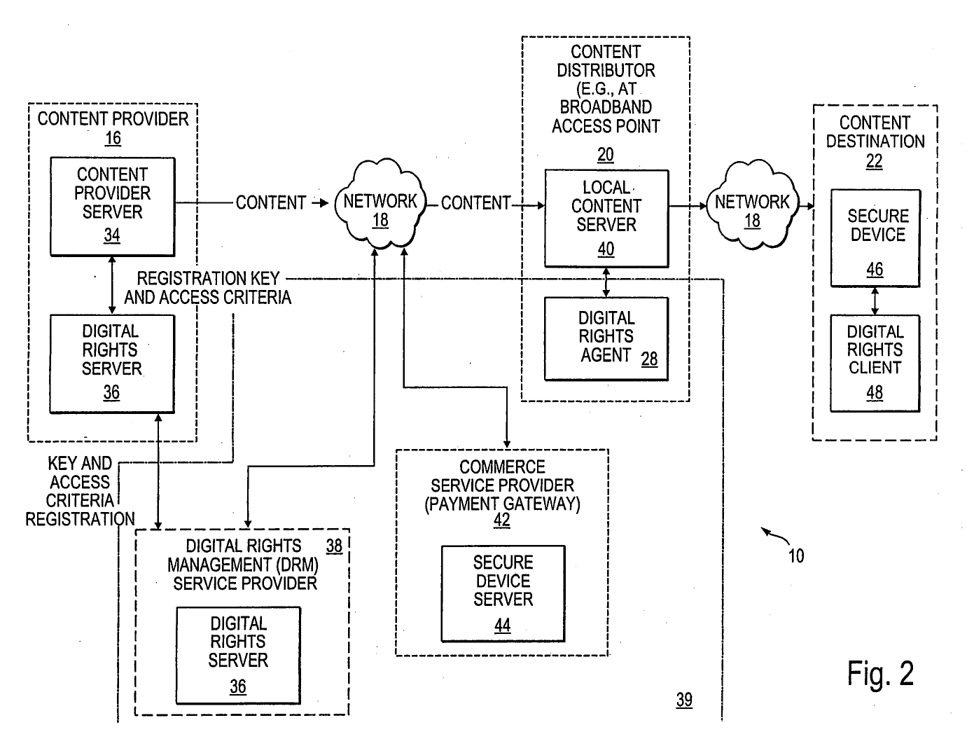

FIG. 2 is a block diagram showing further details regarding software components that may, in one exemplary embodiment, reside at the various locations of the system 10 to facilitate the distribution and delivery processes 12 and 14. The content provider 16 operates a content provider server 34 that is responsible for the actual distribution of content from the content provider 16. For example, the content provider server 34 may comprise a streaming media server (e.g., the Real Networks streaming media server developed by Real Networks of Seattle, Washington State or a Microsoft media server developed by Microsoft of Redmond, Washington State). A digital rights server 36 (e.g., the Entriq Server developed and distributed by Entriq of Carlsbad, California) operates to define and store access rights to content of the content provider 16, to perform digital rights management, to encrypt content, and to manage and distributed product keys. To this end, the content provider server 34 and the digital rights server 36 are shown to communicate registration keys and access criteria.

While the digital rights server 36 is shown to reside with a content provider 16, in an alternative embodiment, a digital rights server 36 may reside at a digital rights service provider (ASP) 38. In this case, the digital rights server 36 may perform the above-described functions for multiple content providers 16. In one embodiment, a collection of the digital rights servers 36 may operate as a nucleus of a digital rights network 39.

The exemplary content distributor 20 is shown to host a local content server 40 and a digital rights agent 28. Alternatively, the digital rights agent 28 may be located remotely from the content distributor 20, and accessed by the content distributor 20 via the network 18. The local content server 40 may again be a streaming media server that streams cached (or freshly received) media. The digital rights agent 28 operates to provide intelligent content and revenue security to content providers 16 by processing access and revenue criteria, personalizing content for delivery to a content destination 22, and personalizing and managing key delivery to a content destination 22. Broadly, the digital rights agent 28 operates securely to authenticate a content destination 22 (e.g., utilizing secure tokens and X.509 certificates), securely to retrieve and cache product key information and content rights (e.g., access criteria), and to forward processed transactions to a commerce service provider 42 (e.g., a CRM operator) that provides billing and clearance services. For example, a digital rights agent 28 may evaluate a content request, received at the content distributor 20 from a content destination 22, based on access criteria specified by a content provider 16, local date and time information, and user credentials and authentication. If a content destination 22 is authorized and/or payment is cleared, requested content might optionally be decrypted, personally watermarked, personally re-encrypted and delivered to the content destination 22.

In one embodiment, a number of digital rights agents 28 and digital rights servers 36 may together constitute a digital rights network (DRN) 39 to which the content provider 16, the content distributor 20, the commerce service provider 42 and the content destination 22 each have access in the capacity of “users” of the digital rights network 39 for their respective purposes. Further details regarding such a digital rights network 39 are provided below.

A content destination 22 is shown to include a secure device 46 (e.g., a copy-protected device such as a set-top box (STB)) and to host a digital rights client 48. The digital rights client 48 may reside on a personal computer or on the secure device 46. Where the digital rights client 48 resides on a personal computer it may, for example, launch responsive to the issuance of a request from a further client program (e.g., a browser) for access certain content. The digital rights client 48 operates to communicate a public key of the secure device 46 to a digital rights agent 28 and also performs user authentication to verify that a particular user is authorized to initiate a transaction. The digital rights agent 28 utilizes copy-protected device technology to stream content to a viewing device.

To review, the content distribution system 10 is implemented by a distributed collection of digital rights servers 36, digital rights agents 28, and digital rights clients 48 that operate in conjunction with media servers and viewing devices (e.g., players) to protected the rights of a content provider 16 in specific content, while facilitating the widespread distribution of content. A digital rights server 36 enables the content provider 16 to encrypt and associate access criteria (e.g., pay-per-view, pay-per-time, subscription) with content. The digital rights server 36 also manages subscriptions and provides monitoring and statistic tools to a content provider 16. A digital rights agent 28 is a cryptographic component that insures that content rights (e.g., access criteria), as defined by content providers 16, are enforced. Digital rights agents 28 are located within a distribution network (e.g., at an edge server) and validate subscriber content requests against, for example, content access criteria, local date and time, and subscriber credentials. A digital rights client 48 is located at a destination device (e.g., the PC, a STB, and mobile phone, game console or the like) and manages an interface between a secure device 46 and a subscriber.

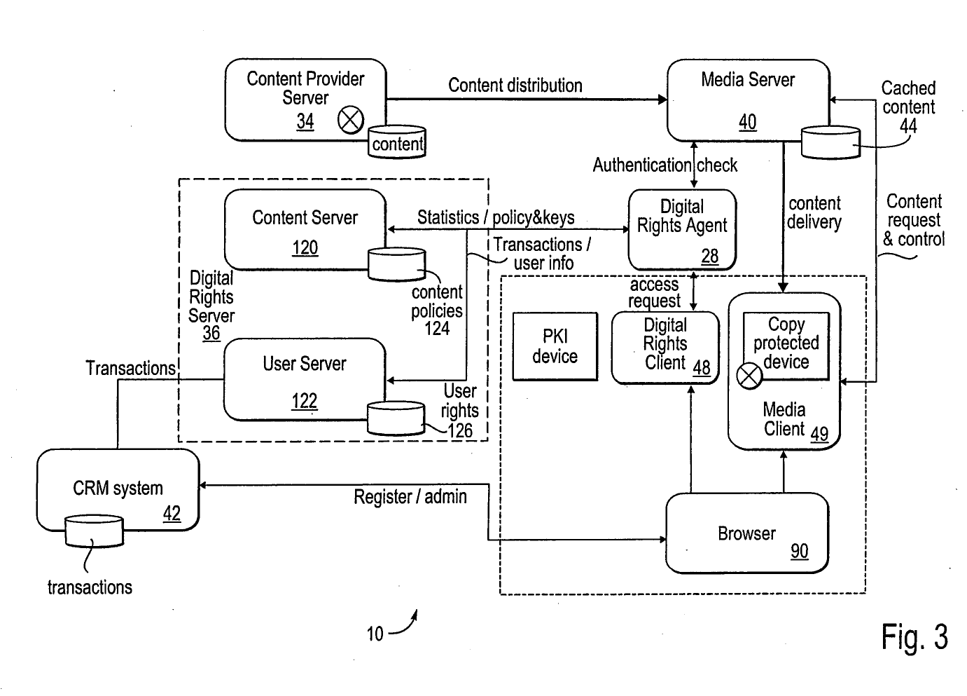

FIG. 3 is a block diagram showing further architectural details regarding an exemplary embodiment of a content distribution system 10. The functioning of the various components of the content distribution system 10, as shown in FIG. 3, will now be the described in the context of registration, content ordering and transaction processing operations.

The content distribution system 10 consists of a number of sub-systems that together provide a required functionality. In one embodiment, these sub-systems seek to enable the Internet infrastructure to be utilized as a safe and secure medium for online selling and buying of content, data, programs, products and services context, including video and audio encoders, servers, players, clearing systems and existing Web sites.

The content distribution system 10, in one embodiment, seeks to provide at least the following functions:
(1) Conditional access to management through various access criteria schemes.
(2) End-to-end content security and copy protection, using encryption and watermarking technology.
(3) Transaction and purse management, using Public Key Infrastructure (PKI) and extensible Markup Language (XML) technology.
(4) Pay-per-view, pay-per-time and subscription based access.
(5) Access control on the basis of region and date/time.
(6) Varying prices on the basis of region and date/time.
(7) Management of a variety of (debit and credit) purses.
(8) Scaling to many (simultaneous) subscribers using a highly distributed architecture.
(9) Secure device portability, using the standard PKCS#11 interface.
(10) User platform portability by defining an interface based on HTTP and XML, allowing a range of subscriber platforms (PC/STB/GSM).

The above listed functions, in one embodiment, are enabled primarily by the following components:
(1) Digital rights clients 48 are located at content destinations 22 to sign content transactions and manage the content decryption process. The digital rights clients 48 may each operate in conjunction with a secure device 46 (e.g., an e-Token or smart card).
(2) Digital rights servers 36, within a digital rights network 39, that are accessible by content providers 16 (e.g., via DRM service providers 38). In the digital rights service provider embodiment, a content provider 16 may access a website operated by a digital rights management (DRM) service provider 38 to secure content and to define access conditions (e.g., pay per view, subscription, etc) associated with the content. As illustrated in FIG. 3, a digital rights server 36 includes a content server 120 and a user server 122. The content server 120 hosts (e.g., stores and facilitates retrieval of) registered content items, and content rights (or content owner rights) 124, for a number of content providers 16. The user server 122 hosts (e.g., stores and facilitates retrieval of) registered users (or content consumers), and associated user (or content consumer) rights 126, for a number of users.
(3) Digital rights agents 28 are located at various points within the digital rights network 39 to act as “brokers” enforcing the business rules and security settings that are associated with content by content providers 16. Digital rights agents 28 also include encryption capabilities to enable the performance of cryptographic operations with respect to access operations relating to one more digital rights servers 36 (e.g., access operations to user rights 126 stored by a user server 122 and access operations to content rights 124 stored by a content server 120). A further discussion of such access operations is provided below. The digital rights agents 28 also include watermarking capabilities to increase the level of security ‘at the last mile’.
User servers 122 may be access by commerce service providers 42 (e.g., pay-media or Customer Relationship Management (CRM) operators) or payment gateways to manage secure devices and associated purses in the field.

FIG. 3 illustrates the interactions and communications between the above-mentioned components of the digital rights network 39. The components of the digital rights network 39 are also shown to interface with various third party components and systems. The user server 122 interfaces with a commerce service provider 42 in the form of external CRM system to forward transactions and user events. The content aggregator or an Internet Service Provider (ISP) typically hosts the CRM system. The value of the transaction is settled with the various parties (content owner/provider, network provider/ISP, clearing house, etc). The digital rights network 39 allows external systems to register and un-register users, and control debit, credit, subscriptions and other user rights.

The digital rights client 48 may interface with a PKI device at the subscriber PC or other media device. Example PKI devices are software certificates, hardware smart cards or e-Tokens. The digital rights network 39 supports both the PKCS#11 as well as the Microsoft CSP interface to remain device independent. The digital rights client 48 also interfaces device with non-PC client platforms such as Set Top Boxes, PDA's and mobile telephones enabled with (smart card) PKI technology.

The streaming media server 40 notifies the digital rights agent 28 when a user starts and stops the streaming process for security and tracking purposes utilizing plug-ins for various streaming media technologies (Microsoft, Real, MPEG-4) and platforms (Windows, UNIX).

Further details regarding the functions and architecture of the components of the digital rights network 39, according to one exemplary embodiment of the present invention, are now discussed.

Overview—Digital Rights Network

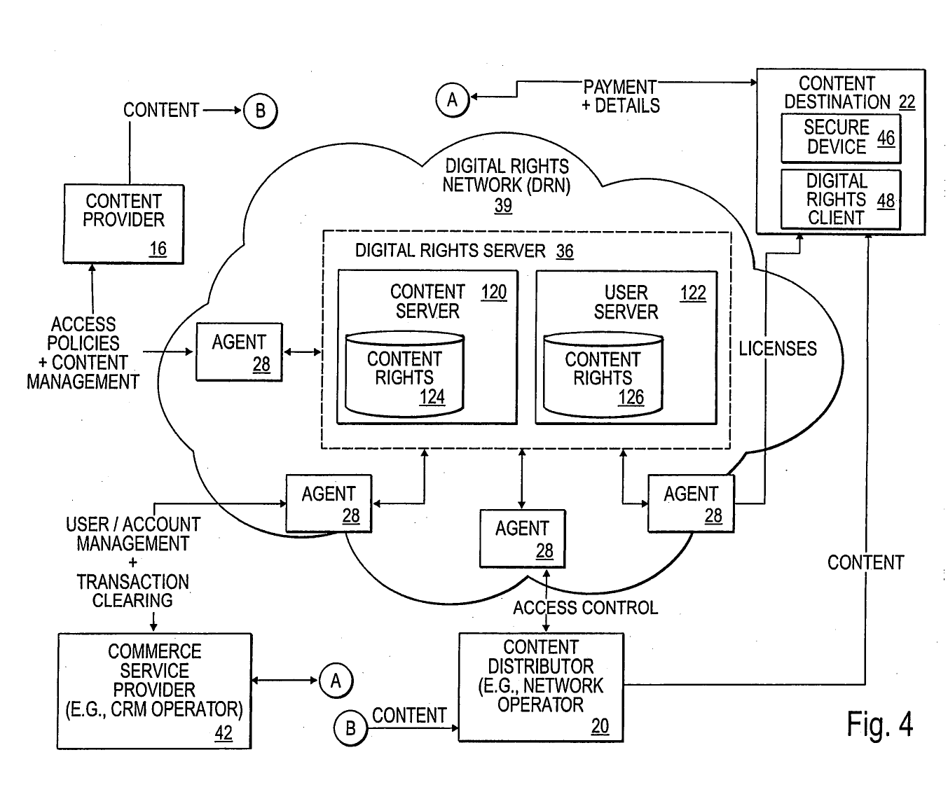

FIG. 4 is a diagrammatic representation of an exemplary deployment of the digital rights network 39, according to one embodiment of the present invention, and illustrates the interactions of a content provider 16, a content distributor 20, a commerce service provider 42 and a content destination 22 with the above-described components of the digital rights network 39. As illustrated in FIG. 4, the digital rights agents 28 are the main entry points (or gateways) into the digital rights network 39 via which access operations with respect to the content rights 124 and user rights 126 are performed. To this end, most cryptographic operations (e.g., user authentication, license creation, data encryption, data decryption, signing and signature verification) are handled by a distributed collection of digital rights agents 28, with ‘data’ referring to data stored in the digital rights network 39 including content keys, content access policies and user rights. In one embodiment, data encryption and signing (e.g., of keys and data) are performed exclusively by the digital rights agents 28, so that the content and user servers 120 and 122 have very little, or no, cryptographic capabilities and are utilized solely to store and retrieve data.

From the perspective presented in FIG. 4, it will be appreciated that all entities outside the digital rights network 39 may be regarded as “users” of the digital rights network 39. In one embodiment, each such a “user” has one or more certificates that are utilized to authenticate the user to a digital rights agent 28. In the situation where the user is a content consumer (e.g., a subscriber), a certificate may be bound to certain user rights 126 that the user may have acquired through, for example, a content distributor 20 (e.g., a network operator). A user may furthermore have multiple certificates, each certificate being for a one of multiple devices at one or more content destinations 22, such as a PC at home, a PC at work and a PDA for travel. The digital rights network 39 manages the logical links between certificates and user rights, as indicated by the CRM operator.

The digital rights network 39 operates to facilitate access operations (e.g., registration, storage, retrieval and verification) with respect to the content and user rights 124 and 126. Certain users of the network 39 require rights to access content (e.g., the content consumer), to register content and content keys (e.g., the content provider 16), to update content rights (e.g., the content provider), and to register and update user rights (e.g., the commerce service provider 42 or the content distributor 20). The digital rights network 39, as illustrated in FIG. 4, seeks to facilitate the access operations with respect to such rights, and to enable the management of such rights.

While FIG. 4 illustrates a single digital rights server 36, the digital rights network 39 may include a distributed set of digital rights servers 36 that are utilized to host the content and user rights 124 and 126. Such servers 36 may be located at strategic locations on the digital rights network 39. All queries, updates, registrations and exercises of rights (e.g., content or user rights 124 or 126) take place by issuing appropriate requests from a “user” to a digital rights agent 28. For example, where a content provider 16 performs an access operation with respect to the content rights 124 to register content and submit an appropriate content key into the network 39, the digital rights agent 28 verifies that the content provider 16 (as a network “user”) has the rights to register content. Where a commerce service provider 42 (e.g., a content aggregator or CRM operator) performs an access operation to bind content to a specific policy, the digital rights agent 28 verifies whether the commerce service provider 42 as the rights to bind the relevant content items to the relevant policy. Where a content distributor 20 (e.g., a network operator) performs an access operation to modify the user rights of a specific content consumer, the digital rights agent 28 operates to verify that the content distributor 20 has the rights to update the relevant user rights. As such, the user rights 126, in one embodiment of the present invention, may record the rights of all “users” of the digital rights network 39 to perform access operations with respect to the network 39. For example, the user rights 126 may include records of: (1) the rights of the content provider 16 to register content, register access policies relating to the content, to register keys for the content, and to perform management of the content; (2) the rights of commerce service providers 42 to establish and manage user (or account) rights for content consumers; (3) the rights of content distributor 20, with which a content consumer may have relationship, to change the user rights of a content consumer (e.g., where the content consumer subscribes to new content); and (4) the rights of a content consumer (e.g., a subscriber) to access certain content via a device as a content destination 22.

In one embodiment, all users of the digital rights network 39 are authenticated with standard X.509 certificates and the Secure Socket Layer (SSL) transport protocol (client and service authentication). Depending on the content access policy configuration, users of the network 39 may also be allowed to authenticate themselves using a user name and password.

Between a user and a digital rights agent 28, data may be protected utilizing transport layer SSL. Within the digital rights agent 28, content keys and access policies 124 and user rights 126 are encrypted and signed before they are stored within the network 39 at one or more digital rights servers 36. In this way, unauthorized access by an administrator of the network 39 (or by a hacker) is combated.

A digital rights agent 28 also operates to create licenses for distribution to a content destination 22 so as to allow a content consumer to access specific content. Licenses for content may be created within the digital rights agent 28 utilizing a variety of license formats, based on the relevant user secure media player 46. In some cases, content may be delivered in the clear, but access to the content limited through a simple access control (i.e., content is not delivered from a content distributor 20 until user rights of a content consumer to access the content have been cleared).

Referring specifically to FIG. 4, a content provider 16 is shown to access the digital rights network 39, via a digital rights agent 28, to store access policies with respect to content within the network 39, and to perform content management. In one embodiment, an access policy describes conditions under which access to content (e.g., audio, video or data) is provided to a content consumer. Access policies (or content policies) including access criteria are defined by the content provider 16 and are associated with registered content, the content typically being encrypted with a key, as described above. Examples of policies include payments policies (e.g., pay-per-view, pay per time), geographical constraint policies, time constraint policies and subscription policies). A policy may specify rules and conditions (or criteria) governing access to content (e.g., subscription, payments, age or region criteria). Content management that may be performed by the content provider 16 includes encoding, encrypting, indexing, archiving and delivery of content. Encryption keys are registered with the digital rights network 39 and associated with the appropriate content item and access policies. The content provider 16 is also illustrated to distribute content to a content distributor 20, as described above with reference to FIG. 1, for caching and/or delivery to a content consumer.

FIG. 4 illustrates a commerce service provider 42 (e.g., a CRM operator) as performing user (or account) management and transaction clearing access operations relating to the digital rights network 39 via a digital rights agent 28. Where the commerce service provider 42 comprises a CRM operator, performing customer care, billing and invoicing, clearing, settlement and data warehousing functions. The CRM operator may access the digital rights network 39 to post and retrieve user rights. Such functions may be performed with respect to accounts maintained within the digital rights network 39. Multiple users may share a single account (e.g., employees of the company or members of a family) and account may be an entity financially responsible for a number of users. The commerce service provider 42 is also shown to be in communication with a secure device 46 at a content destination 22 for the purposes of receiving payment (and other details) pertaining to a user (or account). Specifically, a content consumer, via a secure device 46, may authorized a payment for certain subscription rights to specific content, the details of this payment being communicated to the commerce service provider 42. The commerce service provider 42 may then update an account within the digital rights network 39 to reflect the payment.

A content distributor 20 (e.g., a network operator) is illustrated to perform access control (e.g., to query user rights 126 of a content consumer) via a digital rights agent 28 for the purposes of, for example, issuing a key with which the content consumer can decrypt certain content delivered to the appropriate content destination 22, or for the purposes of, for example, issuing clear content to the content destination 22. The content distributor 20 may also perform update operations with respect to user rights 126 of a content consumer responsive to purchase or subscription actions communicated via a content consumer to the content distributor 20. For example, where the content distributor 20 is a cable network operator, a content consumer may subscribe to particular pay-per-view content, in which case the content distributor 20 updates the user rights 126 for the content consumer to indicate that the user has a right to access the relevant pay-per-view content.

The content destination 22 (e.g., a secure device 46 operated by a content consumer) is shown to request and receive licenses from a digital rights agent 28. In one embodiment, the digital rights agent 28 issues a license on behalf of a content rights owner (e.g., a content provider 16), and a commerce service provider 42 (e.g., a CRM operator) for a content consumer. The license is issued if an access policy associated with the requested content is satisfied, and the content consumer's account is in order. Such a license typically contains a content decryption key, and certain rules governing the use of the decryption key. The content destination 22 is also shown to receive content from the content distributor 20, this content typically being encrypted and requiring the above-mentioned content decryption key for access.

The functioning of the digital rights network 39 illustrated in FIG. 4 will now be described in terms of general functionality, and thereafter in terms of exemplary (1) content registration and protection, (2) content ordering and (3) transaction processing operations.

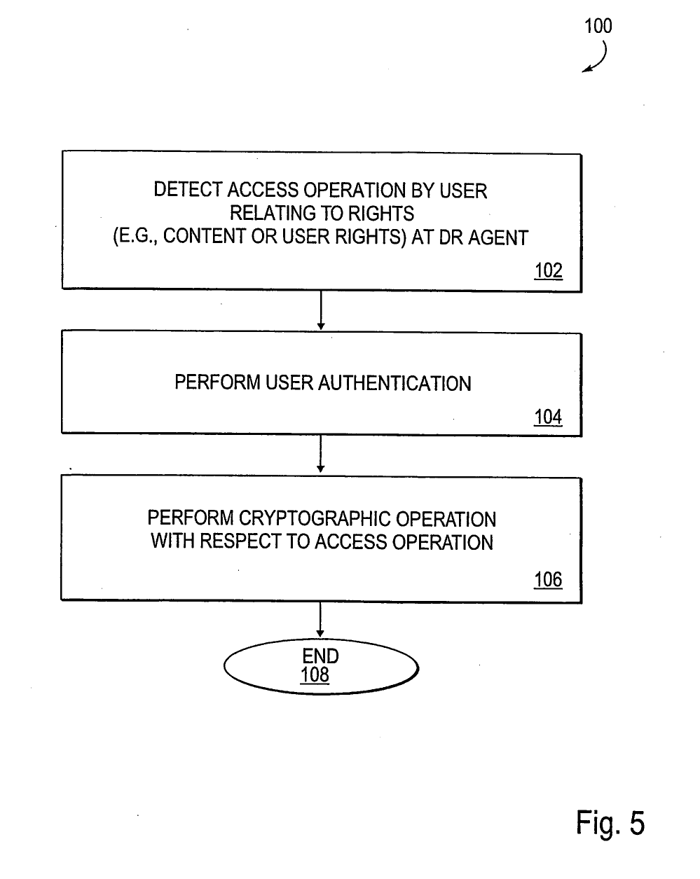

FIG. 5 is a flowchart illustrating a method 100, according to an exemplary embodiment of the present invention, of operating a digital rights network 39, where a plurality of digital rights agents 28 act as gatekeepers for access operations relating to the digital rights network 39 by all users of the digital rights network 39. The method 100 commences at block 102 with the detection by a digital rights agent 28 of an access operation, originated by a user, relating to rights that are stored, maintained and managed within the digital rights network 39. The access operation, it will be appreciated, may depend upon the nature of the user and may include, for example, a rights query, a rights updates, a rights registration, a rights de-registration or a rights exercise operation. The access operation may also be with respect to either the content rights 124 hosted by a content server 120, or the user rights 126 hosted by a user server 122. Exemplary manners in which such access operations may be directed towards a digital rights agent 28 are discussed for the detailed below.

At block 104, the digital rights agent 28 then performs a user authentication operation (or verification operation) in order to verify that the relevant user is indeed authorized to access the digital rights network to perform the relevant access operation.

At block 106, in authenticating and verifying the user and in facilitating the relevant access operation, the digital rights agent 28 performs one or more cryptographic operations with respect to the authentication operation and the access operation to ensure the security of the content rights 124 and user rights 126 as stored within the digital rights network 39. Such cryptographic operations may include, for example, identification, license encryption, content and user data decryption, and signature verification. The flow of the method 100 then terminates at block 108.

For the purpose of the immediately following description, assume that a content provider 16 has already decrypted the relevant content item. Live content requires a slightly different approach at the initial stage of content protection (real-time encryption is required).

Content Registration and Protection Operation

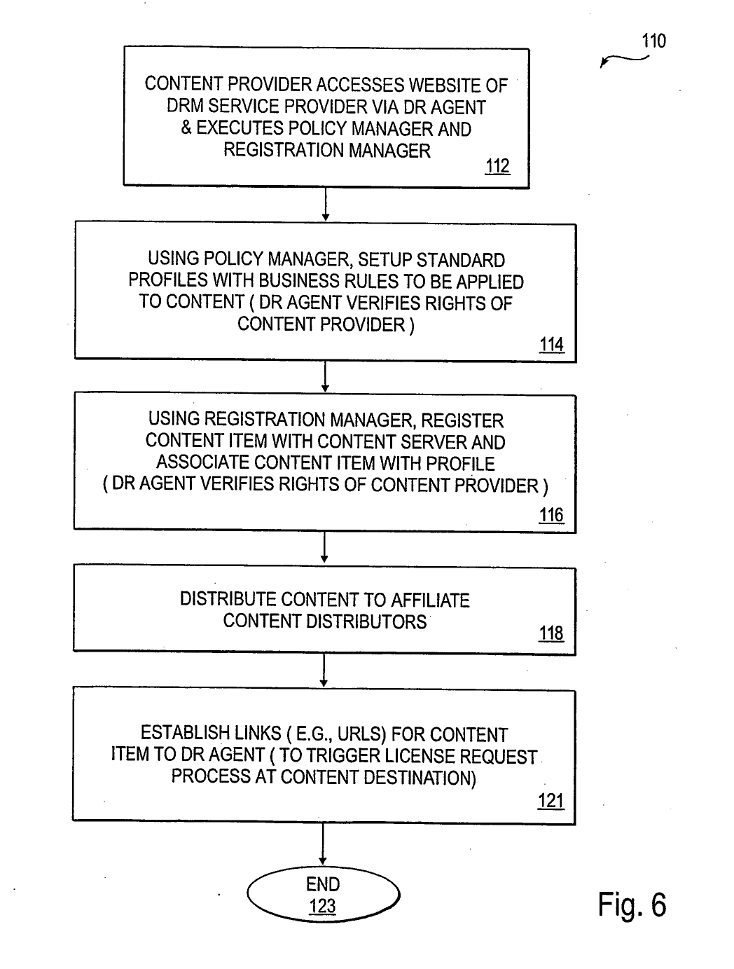

FIG. 6 is a flowchart illustrating a method 110, according to an exemplary embodiment of the present invention, of performing a content registration and protection operation. The method 110 commences when a content provider 16 has a content item that needs to be secured from unauthorized access.

At block 112, the content provider 16 accesses a web server operated by the digital rights management (DRM) service provider 38, from which the content provider 16 downloads a (or alternatively runs a web-based) content security management application that includes a policy manager and a registration manager.

At block 114, the content provider 16, utilizing the policy manager, sets up a number of standard profiles with business rules (e.g., pay-per-view, pay-per-time, regional control etc.) that may later be applied to individual content items.

At block 116, the content provider 16, utilizing the registration manager, secures (e.g., encrypts) the relevant content item with particular access criteria that may be embodied in a standard profile created at block 114. The content is registered at the content server 120, operated by the digital rights management (DRM) service provider 38, together with the access criteria and a product key that was used for encryption of the content. The content is thus secured and may now be distributed using, for example, unicast or multicast.

In the case of access control, the content item is renamed according to a scheme allowing an application to link the content item to a unique content identifier.

At block 118, the content provider 16 proceeds to distribute the content item to content distributors 20, as illustrated in FIG. 4.

At block 121, the content distributor 20 establishes links, in the exemplary form of URLs embedded in web pages, for the content item. The URLs are user-selectable to trigger a license request process between a secure device 46 and digital rights agent 28. For example, the URL may return HTML or JavaScript to query user credentials (e.g., a PIN code or password), user confirmation (payment) or to download secure content licenses to a media player. The flow for the method 110 then ends at block 123.

A content ordering operation is commenced upon receipt of a request from a content destination 22 (e.g., a user) for specific content. The user may, for example, be running a browser on a personal computer and want to view a content item provided by a particular content provider 16. When selecting the content item, the browser detects a tag containing a URL. The browser passes the URL to the digital rights client 48, also executing on the personal computer, to commence a transaction.

Content Ordering Operation

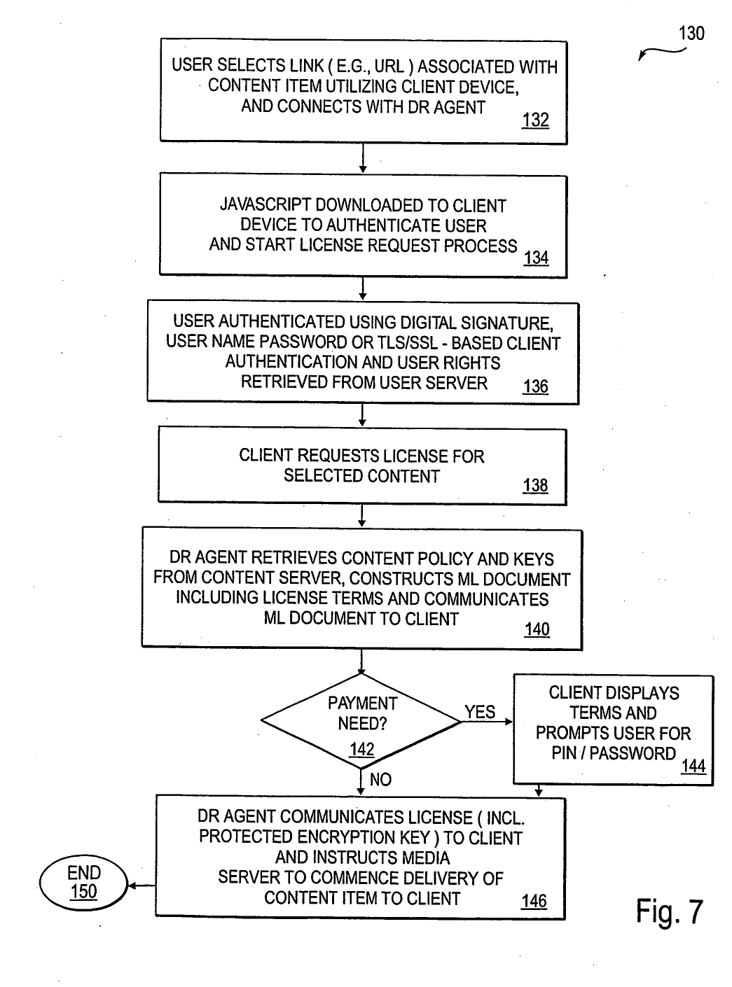

FIG. 7 is a flowchart illustrating a method 130, according to an exemplary embodiment of the present invention, of facilitating a content ordering operation. The method 130 is commenced when a content consumer running a browser on a client machine wishes to view a content item. At block 132, upon user selection of a URL associated with the content item and displayed within a web page, the browser is navigated to a digital rights agent 28. At block 134, the browser downloads identified JavaScript to authenticate the content consumer and to commence a license request process.

At block 136, the content consumer is authenticated by the digital rights agent 28 utilizing a digital signature, username/password or TLS/SSL-based client authentication. Following successful authentication, the digital rights agent 28 proceeds to retrieve appropriate user rights 126 for the content consumer from the user server 122.

At block 138, the browser (via the digital rights client 48) initiates a secure session with a digital rights agent 28 to request a license for the relevant content item. At block 140, if not cached at the digital rights agent 28, the digital rights agent 28 retrieves an appropriate access (or content) policy and content keys for the requested content item from the digital rights server 36. In one embodiment, the digital rights agent 28 constructs a markup language (e.g., HTML) document containing the license terms, and communicates the markup language document to the browser.

At decision block 142, a determination is made as to whether payment is required. If so, at block 144, the browser displays the terms (e.g., price) to the user and may prompt the user for a PIN code or password.

At block 146, if the content item is encrypted, the digital rights agent 128 communicates a license containing a protected encryption key to the secure device 46, and instructs a streaming media server 40 to start streaming the content item to the appropriate content destination 22 until an access time has expired. The flow of method 130 then terminates at block 150.

In an alternative embodiment, the digital rights agent 28 communicates a markup language document in the form of a derived XML signing request to the digital rights client 48 (as opposed to communicating an HTML document to the browser). The digital rights client 48 parses the XML signing request, displays order information (e.g., a price) to the user (e.g., via the browser) and prompts for a Personal Identification Number (PIN) code and confirmation by way of a user interface. In one embodiment, the digital rights client 48 may generate such a user interface for display via a browser 90. In an alternative embodiment, the digital rights client 48 may generate its own user interfaces. The user confirms the order, and the digital rights client 48 digitally signs the order confirmation using the secure device 46. The signed order is sent to the digital rights agent 28 that verifies the signed confirmation order and the user credentials. The digital rights agent 28 manages the content security process (e.g., watermarking, re-encryption) until an access time has expired, after which the content destination 22 will no longer be able to access the content.

Transaction Processing Operation

A transaction processing operation may occur concurrently with the content ordering operation. More specifically, the digital rights agent 28 will update the user rights and forward the updated user data to the user server 122, and send a transaction event to an account management system.

The digital rights client 48 interfaces with the secure device 46 at the content destination 22. Example secure devices 46 are smart cards or e-Tokens. A secure device 46 may utilize the PKCS#11 interface to provided device independent.

The content destination 22 may also employ client devices utilizing non-PC client platforms, such as Set Top Boxes (STBs) and mobile telephones enabled with (smart card) PKI technology. A client device employed at a content destination 22 may run an interactive application (e.g., the OpenTV software suite) to order secure content items using a regular pay television smart card.

The digital rights client 48 and secure device 46 interface with the local content server 40 (e.g., a media server) and client applications to secure a control channel (such as RTSP or HTTP) and data channel (such as MPEG-4 over RTP).

The secure device server 44 provides an interface for external payment registration servers (such as used for regular web sites) to allow automated purse management.

Cryptographic and Other Security Operations

As discussed above, in one embodiment of the present invention, a collection of digital rights agents 28 are responsible for performing the bulk of cryptographic and security operations pertaining to access operations to the digital rights network 39 by users. A discussion of exemplary cryptographic and security operations/technologies that may be utilized by any one of the digital rights agents 28 of the collection of digital rights agents 28 is provided below.

Content Protection/Encryption:

A content provider 16 may utilize Windows Media DRM for encryption and copy protection of Windows Media content (i.e., content encrypted and compressed utilizing technologies developed by Microsoft Corp. of Redmond, Wash.).
A content provider 16 may utilize Real DRM for encryption and copy protection of Real content (i.e., content encrypted and compressed utilizing technologies developed by Real Networks, Inc. of Seattle, Wash.).
A content provider 16 may utilize MPEG-4 IPMP compliant solutions in conjunction with MPEG-4 manufacturers to encrypt MPEG-4 data, according to MPEG-2/DVB principles.
   License Creation and Delivery:
A digital rights agent 28 may utilize Windows Media DRM for generation and delivery of Windows Media licenses.
A digital rights agent 28 may utilize Real DRM for generation and delivery of Real licenses.
They digital rights agent 28 may utilize MPEG-4 IPMP compliant solutions in conjunction with MPEG-4 manufacturers to deliver licenses to MPEG-4 compliant terminals.
   User and Network Authentication:

A client-side HTTPS or username/password may be utilized mutually to authenticate a user of the digital rights network and a digital rights agent 28.

Data Protection:

The digital rights network may utilize HTTPS to protect the link between a user and a digital rights agent 28.

User and Content Rights Data:

While distributed and stored in the digital rights network 39, user and content rights 126 and 124 are protected from unauthorized access and modification.

When hosted, a digital rights management service provider 38, as an operator of the digital rights network 39, utilizes AES to encrypt user and content rights data before the rights data is forwarded to the internal servers (e.g., content and user servers 120 and 122) for storage. When requested, the rights data is retrieved from the appropriate internal server, decrypted and delivered through HTTPS to authorized users. The digital rights agent 28 will enforce (through user authentication) that the user and content data is only provided to authorized users. Encryption is combined with HMAC signatures to prevent modification of the content.

All data belonging to a certain commerce service provider 42 (e.g., a CRM operator) is encrypted with a provider-specific storage key. Digital rights agents 28 retrieve the provider-specific storage key from a central key management systems (not shown) using regular key exchange protocols. The provider-specific storage key may be frequently cycled to minimize damage in case of key exposure.

Access Control:

The digital rights network 39 may utilize media server plug-ins to enforce access control. User credentials are provided by the requesting digital rights client 48 as part of the content request URL (RTSP, MMS) and verified by the plug-in.

Interfaces

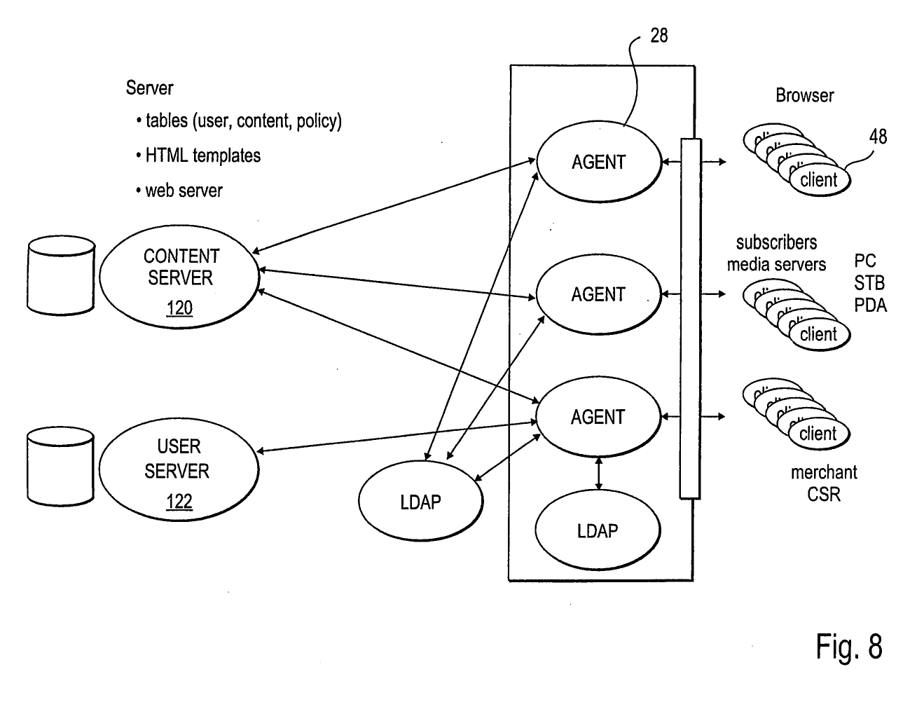

In one embodiment, the digital rights network 39 utilizes XML, HTTP, HTTPS and LDAP for all of internal and external interfaces, as illustrated in FIG. 8. The following URL provides an example of a URL that may be used to post, put and get content from the digital rights network 39:
https://agent.sentriq.net/services/<crmID>/<accountID>/<itemID>/[<search>][?qCrmId=<qCrmID>]

The exemplary HTTP request contains the following elements:
The base URL https://agent.sentriq.net/services/
The requested content ID existing of
   CrmId: The CRM operator ID (e.g., ‘ESPN’) of the requested content.
   AccountId: The account ID (e.g., ‘NBA’) of the requested content owner.
   ItemId: The content item ID (e.g.,‘s34’) of the requested content.
The search string is used for web application content items (e.g., an ASP or Java servlet), where the search-string is appended to the base URL associated with the registered content ID.
The qCrmId provides the CRM operator ID of the requesting user.

Consider the following example URL:
https://agent.sentriq.net/services/Net36/NBA/s34?qCrmId=NBA

This URL may lead to sports content provided by Net36/NBA, using an NBA user account. A non-registered user will be redirected to the NBA registration URL.

Depending on the policy associated with the relevant content, the same content may be accessed through a different PPV site:
https://agent.sentriq.net/services/Net36/NBA/s34?qCrmId=AOL

The digital rights network 39, in one embodiment, identifies a policy associated with a content item by combining the CRM ID, account ID and the item ID and querying internal content and policy tables.

Content may refer to:
1. A key used to encrypt the content. An authorized user will receive a license to decrypt the content (license type is “IPMPv0” or “WDRMv7”).
2. A link to the actual content or a link to the META file (like SMIL or ASX). An authorized user will receive the registered link or the META file combined with additional authentication parameters to request the content.
3. A combination of 1 and 2.
4. Application data that is retrieved (GET) or sent (POST) to a corresponding HTTP application server. Applications are configured by an operator of the digital rights network 39 (e.g., the digital rights management (DRM) service provider 38). Exemplary predefined interactive applications include:
   a. /Sentriq/<CRM ID>/Home, the default page.
   b. /Sentriq/<CRM ID>/Accounts, to manage users & accounts.
   c. /Sentriq/<CRM ID>/History, to view user history.
   d. /Sentriq/<CRM ID>/MyAccount, for customer self-care.
   e. /Sentriq/<CRM ID>/Policy, to manage content policies.
   f. /Sentriq/<CRM ID>/Content, to manage content.
   g. /Sentriq/<CRM ID>/Statistics, to view content statistics.

Exemplary use scenarios for the above applications include:
A content provider 16 may register an MPEG-4 IPMP key without a link to the actual content. The digital rights network 39 will in this case issue a MPEG-4 IPMP license for authorized users and update the user's rights.
A content provider 16 may register a MPEG-4 IPMP key with a link to the actual content. The digital rights network 39 will issue an MPEG-4 4 IPMP license for authorized users and update the user's rights, and redirect the user to the actual content with the appropriate authentication parameters.
A content provider 16 may register a Microsoft DRM key without a link to the actual content. The digital rights network 39 will issue a Microsoft DRM license for authorized users and update the user's rights.
A content provider 16 may register a Real video file without a key but with a link to the actual content. The digital rights network 39 will redirect the user to the appropriate link and update the user's rights.
A commerce service provider 42 (e.g., a CRM operator) may query or edit user rights using the registered user management application.

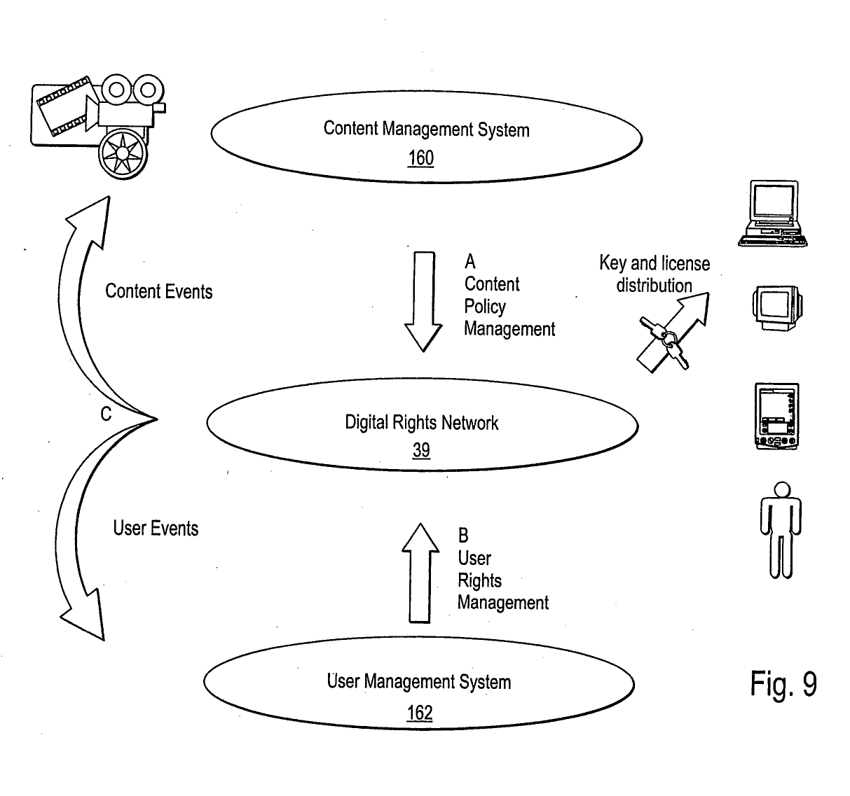

In one embodiment, and as shown in FIG. 9, users of the digital rights network 39 may access to the digital rights network 39 utilizing content management systems 160, to perform content policy management, and user management systems 162, to perform user rights management. To this end, the digital rights network 39 may provide appropriate external interfaces, for example (1) content management interfaces and (2) user management interfaces. Further exemplary external interfaces that may be provided by the digital rights network 39 include (3) an access data interface and (4) a media platform interface.

Content Management Interfaces

The digital rights network 39 may provide default tools for content management, but also allow external applications to automate the content management process. Specifically, the content management interfaces may allow a content provider 16 to configure content access policies (e.g., pricing, geographic control, parental control, subscription, etc.), and allow a content provider 16 to protect and registered content. For example, the digital rights network 39 may provide an interface to:
View and edit content items, e.g.: https://<agent>/services/Sentriq/ESPN/Content
Register and edit content policies, e.g.: https://<agent>/services/Sentriq/ESPN/Policy

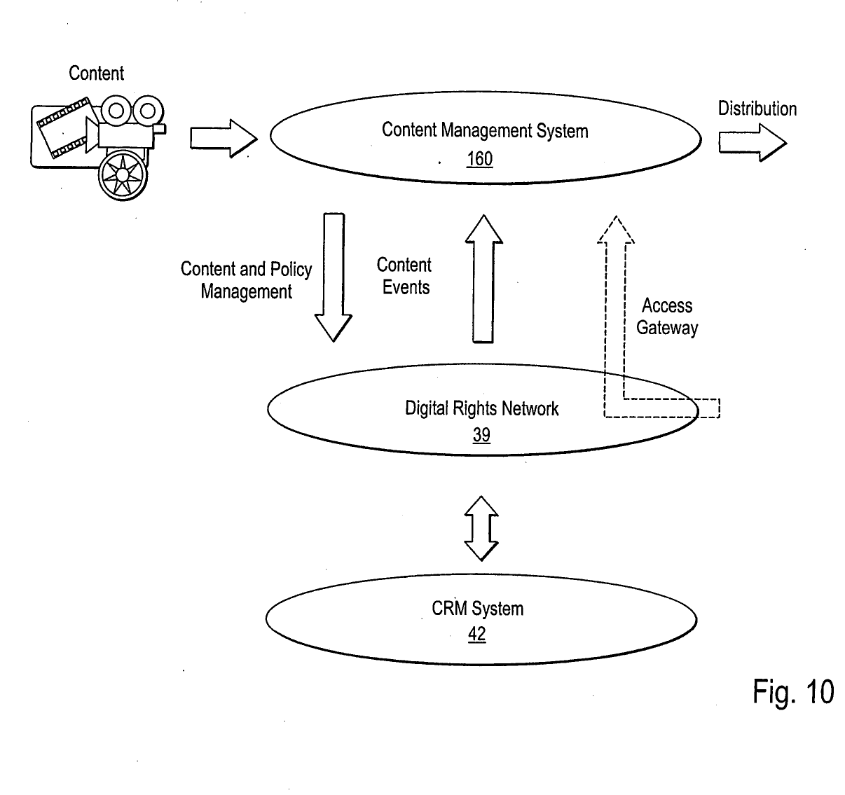

For the purposes of discussion below, a content provider 16 is regarded as being to the responsible for managing content rights. The digital rights network 39, in one embodiment, provides a number of interfaces for accessing, protecting, monetizing and tracking content. The interfaces allow for easy integration into existing content management systems and online content catalogs. Exemplary interfaces, illustrated in FIG. 10, include:
An interface for users to access protected content.
An HTTP server interface allowing a content provider 16 to register content and manage associated access policies. Content rights are exclusively used to enable protected Internet Media distribution and to provide detailed statistics and demographics to the content provider.
Content events are afforded to the CRM system.
An access gateway interface for authenticated user HTTP requests. This allows a for example, for personalized promotion and advertisement insertion.

In one embodiment, content items are identified by the triplet CrmId—AccountId—ItemId:
CrmId, identifying a managing CRM operator (e.g., ESPN)
AccountId, to identify the merchant account (e.g., ‘LaLakers’).
ItemId, identifying the content item (e.g., ‘Game15_{—}2’)

A content item can be a single piece of content (streaming media), a subscription or an interactive web application.

Content policies may be identified by the triplet CrmId—AccountId—PolicyId.

A description will now be provided regarding an exemplary access operation whereby a user may access content utilizing the content management interface. A user can access content items that have been registered with the digital rights network 39 via the content management interface. The user may be requested to provide a payment or a PIN code before access to content is granted, depending on content access policy and user settings. After acquiring the rights, the user may be redirected to an external source for content delivery (in case of streaming media). The user may be redirected to a CRM specific registration site if he has no account.

Below is an example of an API that may be utilized to GET a content item:
https://agent.sentriq.net/services/<CrmId>/<AccountId>/<ItemId>[<search>]

‘Search’ can contain the following parameters:
QCrmId: The CRM ID of the requesting user (e.g., a network operator).
ReturnUrl: The URL that should be followed after acquiring the license (no content).
SyndicatorCrmId and SyndicatorAccountId: The CRM ID and account ID of the syndicator that brought the user to the content item. This parameter can be used for settlements by the clearing CRM operator.

Furthermore, the user authentication process can be made ‘non-interruptive’ by POSTING the necessary user credentials:
Username (to authenticate the user)
Password (to authenticate the user)
Pin (to confirm a payment or parental control block)

If these parameters are not provided, the user will be prompted for the required credentials.

Below is provided an example URL that may be utilized to get a content item for account ‘LaLakers’ content item ‘Game15_{—}2’.
https://agent.sentriq.net/services/Sentriq/LaLakers/Game15_{—}2?QCrmId=iBill

A description follows of an exemplary access operation whereby a content provider 16 can register and query content items with the digital rights network 39 and associate the content item with an access policy.

The content item can be, for example:
Streaming media event(s).
Download media.
A product/subscription.
An interactive web application.

In one embodiment, the digital rights network 39 provides web-based tools to manage content items. The interfaces described are provided to allow advanced integration into content management systems, such as automated content registration.

The following is an exemplary API that may be utilized to POST or GET content information:
https://agent.sentriq.net/services/Content?QueryId=Content[<search>]

‘Search’ can contain the following parameters:
CrmId: The ID of the content CRM operator.
AccountId: The ID of the content account.
ItemId: The ID of the content item.
Type: Content type (when creating a new content item)
QCrmId: The CRM ID of the requesting user (operator).

In case of GET, the HTTP response contains the XML document with the content information. In case of POST, the HTTP request contains an XML document containing the content information (text/xml), or a single POST parameter (‘content=<ContentXmlData>’).

The following example URL is used to query (GET) or set (POST) content data for account ‘LaLakers’ content item ‘Game15_{—}2’.
https://agent.sentriq.net/services/Content?QueryId=Content&CrmId=Sentriq&AccountId=LaLakers&ItemId=Game15_{—}2&QCrmId=Sentriq

A description follows regarding an exemplary access operation whereby a content provider 16 can query the content policies that are available for a certain policy type.

The following exemplary API may be utilized to GET available policies:
https://agent.sentriq.net/services/Content?QueryId=PolicyList[<search>]

‘Search’ can contain the following parameters:
CrmId: The ID of the content CRM operator.
AccountId: The ID of the content account.
QCrmId: The CRM ID of the requesting user (operator).

The HTTP response contains the XML document with the available policies. Specification’. The following exemplary URL is used to query (GET) available content policies for account ‘LaLakers’.
https://agent.sentriq.net/services/Content?QueryId=PolicyList&CrmId=Sentriq&AccountId=LaLakers&QCrmId=Sentriq

A description follows regarding an exemplary access operation whereby a content provider 16 can query content data and the associated policy using a single request. The following exemplary API may be utilized to GET the content and policy data:
https://agent.sentriq.net/services/Content?QueryId=ContentPolicy[<search>]

‘Search’ can contain the following parameters:
CrmId: The ID of the content CRM operator.
AccountId: The ID of the content account.
ItemId: The ID of the content item.
UserCrmId: The ID of the user CRM operator. (The policy may vary depending on the user's CRM id and roaming agreements.)
CountryId: The country ID.
RegionId: The region ID.
QCrmId: The CRM ID of the requesting user (operator).

The HTTP response contains the XML document with the content and policy data. The following exemplary URL is used to query (GET) content and policy data for item ‘Game5_{—}21’.
https://agent.sentriq.net/services/Content?QueryId=ContentPolicy&CrmId=Sentriq&AccountId=LaLakers&ItemId=Game5_{—}21&QCrmId=Sentriq

A content provider 16 can manage content policies hosted within the digital rights network 39. The content policy identifies the content access criteria such as a payment, a subscription or other criteria. The following exemplary API may be used to POST or GET content policies:
https://agent.sentriq.net/services/Content?QueryId=Policy[<search>]

‘Search’ can contain the following parameters:
CrmId: The ID of the content CRM operator.
AccountId: The ID of the content account.
PolicyId: The ID of the policy.
UserCrmId: The ID of the user CRM operator. (The policy may vary depending on the user's CRM id and roaming agreements.)
CountryId: The country ID.
RegionId: The region ID.
QCrmId: The CRM ID of the requesting user (operator).

In case of GET, the HTTP response contains the XML document with the policy data. In case of POST, the HTTP request contains an XML document containing the policy data (text/xml), or a single POST parameter (‘content=<PolicyXmlData>’).

The following exemplary URL is used to query (GET) or set (POST) policy data for account ‘LaLakers’ content policy ‘PremiumGames’.
https://agent.sentriq.net/services/Content?QueryId=Policy&CrmId=Sentriq&AccountId=LaLakers&PolicyId=PremiumGames&QCrmId=Sentriq
   User Management Interfaces

The digital rights network 39 may provide default tools for user management, but also allows for external applications to automate the user management process. Specifically, the user management interfaces may allow a CRM operator to register users, and manage their rights, including subscriptions, parental, regional and debit/credit control. For example, the digital rights network may provide an interface to:
Register and edit user rights and information, example: https://<agent>/services/Sentriq/Net36/User
Register and edit account information, example: https://<agent>/services/Sentriq/Net36/Account

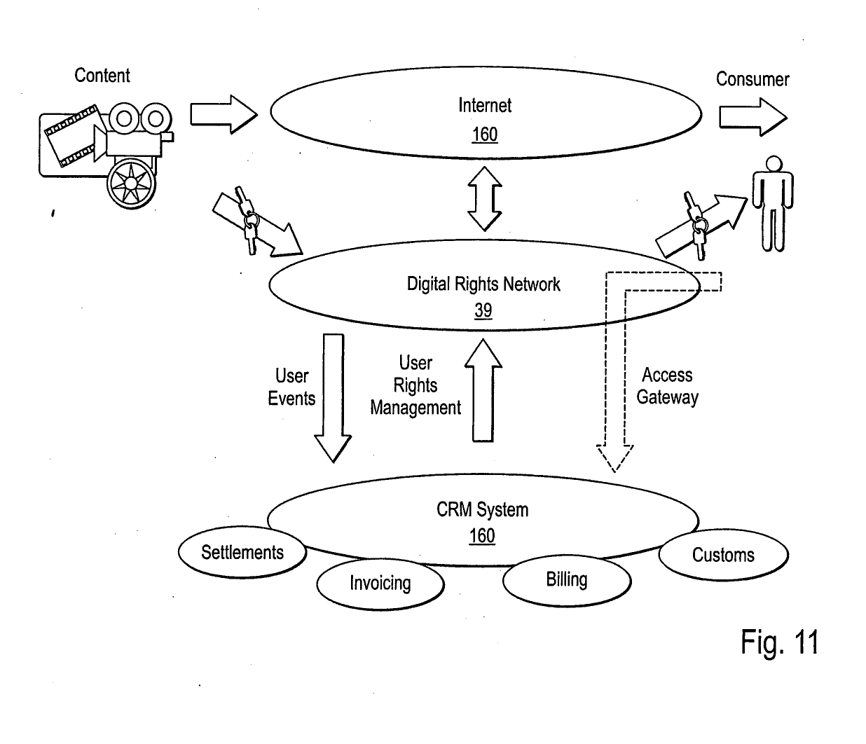

For purposes of illustration, a CRM operator is, in the below exemplary discussion, regarded as being organization responsible for managing the account relationships. In one embodiment of the present invention, the digital rights network 39 provides an interface for effective and secure user/account management. The interface allows for easy integration with existing CRM systems 160, as illustrated in FIG. 11.

More specifically, the digital rights network 39 in one embodiment provides an HTTP server interface to allow a CRM operator to register users or ‘subscribers’ and associate users with rights, such as debit, credit and subscriptions. Subscriber information and rights may be exclusively used to enable protected Internet Media transactions. Subscriber information is typically not forwarded to content owners without the explicit request of the CRM operator.

The digital rights network 39 forwards user events (e.g., Internet broadcast Pay Per View transactions) to the CRM system 160. The digital rights network 39 also provides an access gateway interface for authenticated user HTTP requests. This allows, for example, a CRM operator to securely manage access of users and CRM customer service operators to the CRM system 160.

Within the digital rights network, users are in one embodiment identified by the triplet CrmId—Account—UserId:
CrmId, identifying day managing CRM operator, like ‘Net36’, ‘@Home’ or ‘iBill’.
AccountId, allowing the CRM operator to identify the user account, like a CRM specific account id (username) or email address.
UserId, identifying an individual user of the account. The default user ID is 0.

A CRM operator has a relationship with multiple accounts. An account may be associated with multiple users (e.g., in case of corporate accounts), but is often only associated with one user (e.g., in case of traditional Pay Media subscription accounts). All user management messages contain the triplet to identify the associated user. Access rights are defined at a user level.

A description follows of an exemplary access operation, whereby CRM operators can associate users with rights such as subscriptions (entitlements), credit, debit and other user specific settings. The digital rights network 39 provides an HTTP/XML interface to enable the CRM operator to manage user rights. Predefined XML tags are used within the digital rights network to authenticate and authorize users before access to content is granted.

The following exemplary HTTP API is used to POST or GET users rights:
https://agent.sentriq.net/services/User?QueryId=User[<search>]

‘Search’ contains the following parameters:
CrmId: The ID of the user's CRM operator.
AccountId: The ID of the user's account.
UserId: The ID of the user.
QCrmId: The CRM ID of the requesting user (operator). The QCrmId is typically equal to the CrmId. However, there may be occasions that a certain Customer Service Representative can manage accounts for multiple CRM operators.

In case of GET, the HTTP response contains the XML document with the user rights. In case of POST, the HTTP request contains an XML document containing the user rights (text/xml), or a single POST parameter (‘content=<UserXmlData>’).

The following exemplary URL is used to query (GET) or set (POST) user rights for Net36 account ‘smith@home’.
https://agent.sentriq.net/services/User?QueryId=User&CrmId=Net36&AccountId=smith@home&UserId=0&QCrmId=Sentriq

A description follows of an exemplary access operations whereby CRM operators can store and retrieve account data within the digital rights network 39. The digital rights network 39 provides an HTTP/XML interface to enable the CRM operator to manage account data.

The following exemplary API may be used to POST or GET account data:
https://agent.sentriq.net/services/User?QueryId=Account[<search>]

‘Search’ contains the following parameters:
CrmId: The ID of the user's CRM operator.
AccountId: The ID of the user's account.
QCrmId: The CRM ID of the requesting user (operator). The QCrmId is typically equal to the CrmId. However, there may be occasions that a certain Customer Service Representative can manage accounts for multiple CRM operators.

In case of GET, the HTTP response contains the XML document with the account data.

In case of POST, the HTTP request contains an XML document containing the account data (text/xml), or a single POST parameter (‘content=<AccountXmlData>’). The following exemplary URL may be utilized to query (GET) or set (POST) account data for DirecTV account ‘smith@directv.com’.
https://agent.sentriq.net/services/User?QueryId=Account&CrmId=Net36&AccountId=smith@home&QCrmId=Sentriq

A description follows of an exemplary access operation whereby a user (e.g., content consumer) may use multiple devices to access his or her services. In one embodiment, this access operation is undefined if the user is identified utilizing a secure certificate, instead of username/password. Consider the content consumer may need to access a news service using a PC at work, a PC at home or a PDA while traveling. In this case, a CRM operator may be required to manage which and how many devices are mapped to the same user and associated rights. Devices are typically identified using a certificate serial number, telephone number or a device address. The digital rights network 39 facilitates the binding of the device identifier to user rights according to CRM instructions.

The following exemplary scenario explains how a user may be bound to a device:
1. The CRM operator creates a user account with the appropriate rights including a secret user ‘bind ID’ and a ‘bind expire date’). The bind ID can be any random string, and should only be forwarded to the user that will own those rights.
2. The user is redirected to a bind URL (as specified below) before the bind date expires.
3. If the user does not have a certificate, and the user uses a platform that supports certificates, the user will automatically receive a X.509 certificate.
4. If the bind ID of the bind URL matches the bind ID in the appropriate user XML document, and the current date falls within the bind expire date, then the user device ID is bound with the user rights. The bind ID is removed from the user rights to prevent fraud.
5. The user is redirected to the URL as requested by the referrer.

In the exemplary embodiment, a CRM operator can bind user rights to a device (certificate) by redirecting the user to the following URL:
https://agent.sentriq.net/services/Bind[<search>]

‘Search’ contains the following parameters:
CrmId: The ID of the user's CRM operator.
AccountId: The ID of the user's account.
UserId: The ID of the user.
BindId: The ID of the bind request. This ID must match the bind ID as registered with the User XML document (see scenario description).
ReturnUrl: The URL that the user will be redirected to after the process has been completed (default=originating URL). The URL may be encoded (escaped).

The digital rights network 39 operates to depend a return code to the return URL to flag any errors that took place during the bind process:
RetCode=0: OK
RetCode=1: The client platform does not support certificates
RetCode=2: The bind ID is incorrect
RetCode=3: The bind date has expired
RetCode=4: No such account
RetCode=5: System error (e.g. Certificate Authority is down)

The following URL provides an example of how a requesting user may be bound to a Net36 account ‘smith@home’ (if the bind ID and expire date are correct).
https://agent.sentriq.net/services/Bind?CrmId=Net36&AccountId=smith@home&UserId=0&BindId=iu45t7iyu9qp&ReturnUrl=http://register.sentriq.com/reg.asp

Below follows a description of how the digital rights network 39 may grant X.509 certificates to users to enable secure user authentication. The certificate is bound to the user machine and cannot easily be copied to other machines. CRM operators typically do not use this API directly, but use the ‘Bind’ API to provide certificates to users.

A CRM operator can into the exemplary embodiment redirect the user to collect a certificate using the following URL:
http://cert.sentriq.net/getCert[<search>]

The application will generate a certificate for the user and return the user to the originating web page.

‘Search’ contains the following parameters:
E: User email address
CN: Common name
Password: password for getting a certificate
ReturnUrl: The URL that the user will be redirected to after the process has been completed (default=originating URL). The URL may be encoded (escaped).

The digital rights network 39 operates to depend a return code to the return URL to flag any errors that took place during the certificate generation process.

Access Data Interface

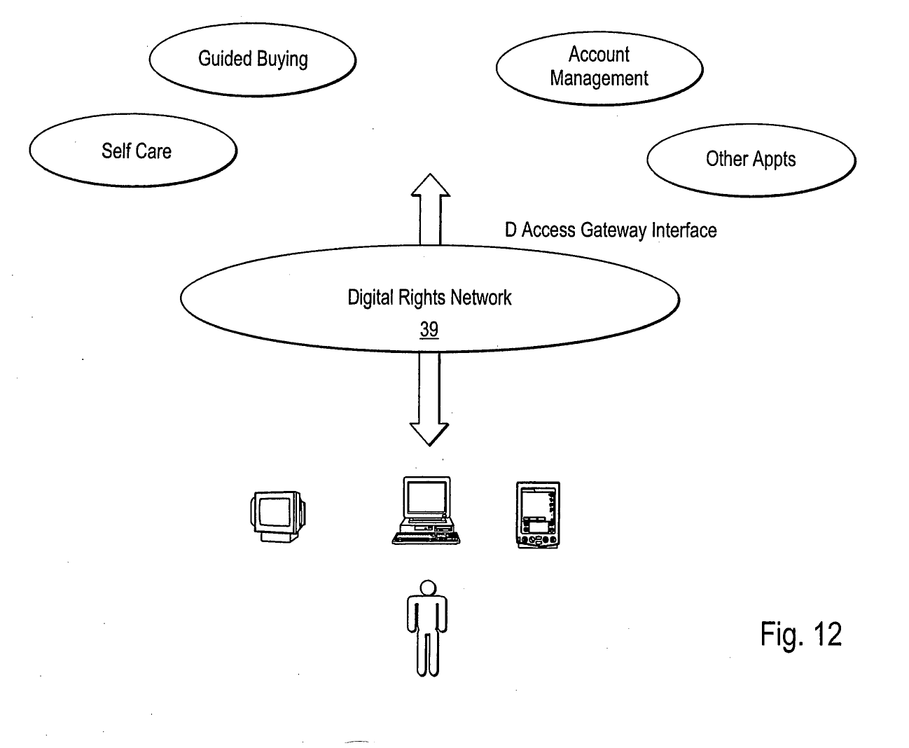

The digital rights network 39 enables service providers to protect and personalized web applications, such as “guided by”, customize self-care” and “account management”. Each web application can be configured with a different access policy, enabling schemes such as subscriptions or even pay per view for accessing online web services. In one exemplary embodiment, as illustrated in FIG. 12, the digital rights network provides the following default applications for a CRM operator:
Home (personalized home page)
Account, for customer self-care.
History, for account history information.
Account Management, for customer service operators

The digital rights network 39 may be viewed as acting like a proxy, and verifies the application access policy and the user rights before forwarding the user HTTP request to the hosted web application. The forwarded HTTP request includes private HTTP header fields particular to the digital rights network 39:
user-rights: This optional field contains the XML user rights XML document, and is omitted if the user has no CRM account.
device-id: This optional field contains the device (authentication) identifier such as the certificate serial number, and is omitted if the user (device) has not been authenticated.
crm-id: This optional field contains the CRM operator ID from the requesting user.
account-id: This optional field contains the account ID from the requesting user.
user-id: This optional field contains the user ID of the requesting user.
ip-country: This optional field contains the ISO country code that has been resolved by the internal geo-locater using the client IP address.
ip-country-confidence: This optional field contains the confidence level of the IP based country identification.

The information held in these fields can be used by the web application to check the users rights and personalize the user experience.

Although the digital rights network 39 can block the user based on the configured access policy, the application server is responsible for checking the values of the private HTTP headers as defined above. The digital rights network 39 will ensure that any invalid private HTTP headers of an incoming request are cleared before forwarding the request, to prevent hackers from masquerading legitimate users.

An exemplary scenario is described below:
1. A browser (optionally operating in conjunction with a digital rights client 48) sends a regular HTTP GET or POST request to the digital rights agent 28 to access the application.
2. The digital rights agent 28 authenticates the user and collects the user rights 126 and the content rights 124.
3. If the user is authorized, the digital rights agent 28 forwards the HTTP request to the appropriate application, including the private HTTP headers containing user information.
4. The application server receives the request and returns a response, tailored to the user's profile.
5. The agent processes the response and returns the reply to the browser (and/or digital rights client 28).

The processing of the response may include the insertion of user or session specific information at the direction of the application server using HTML directives. This is done to personalize the response at the digital rights agent 28 and browser (and/or digital rights client 48) instead of at the central server, allowing for scaleable solutions.

In the exemplary embodiment, user can be directed to one of the applications using the following URL:
https://agent.sentriq.net/services/<App>[search]

‘Search’ must contain at least the following parameter:
QCrmId: The CRM ID of the requesting user.

The following applications (App) are pre-defined:

Home, Account, History, AccountManagement.

The following exemplary URL provides an example how the ESPN Home application may be called:
https://agent.sentriq.net/services/Home?QCrmId=ESPN
https://agent.sentriq.net/services/Account?QCrmId=ESPN
https://agent.sentriq.net/services/History?QCrmId=ESPN

The digital rights agent 28 authenticates the user, verifies access policies and forwards the URL request to the configured application with the private header fields. The response from the application server may contain HTML directives for the digital rights agent 28 to include user, content or session JavaScript objects in the resulting web page. Exemplary HTML directives to generate JavaScript objects are included in the HTML response as follows:
<#Agent Object=<object>[Attribute=<Attribute>]>

The following are examples of directives that may be recognized by the digital rights agent 28:
<#Agent Object=User>
<#Agent Object=Content>
<#Agent Object=Session>

These directives are replaced by JavaScript classes that contain public content, user and session parameters respectively. In addition, a directive may indicate a specific XML attribute as follows:

```
<#Agent Object=User Attribute=Nickname>
For example, the following HTML page:
<HTML>
<HEAD>
<SCRIPT LANGUAGE=”JavaScript”>
<#Agent Object=Content>
<#Agent Object=User Attribute=Nickname>
</SCRIPT>
</HEAD>
<BODY>
<SCRIPT LANGUAGE=”JavaScript”>
document.write (‘<BR>Hi <B>’ + Nickname);
document.write(‘</B><BR>This is’ + Content.Description);
</SCRIPT>
</BODY>
</HTML>
Translates into:
<HTML>
<HEAD>
<SCRIPT LANGUAGE=”JavaScript”>
var Content =
{
  Description: “Eye of the tiger”,
  CrmId: “Sentriq”,
  AccountId: “ESPN”,
  ItemId: “TigerEye”
};
var Nickname = “Roberto”;
</SCRIPT>
</HEAD>
<BODY>
<SCRIPT LANGUAGE=”JavaScript”>
document.write(‘<BR>Hi <B>’ + Nickname);
document.write(‘</B><BR>This is’ + Content.Description);
</SCRIPT>
</BODY>
</HTML>
```

Media Platform Interfaces

The digital rights network 39 may be integrated with a number of the media platforms, such as Windows Media Technology (including Windows Media DRM) and Real. The digital rights network 39, in one embodiment, seeks to be media platform agnostic, but requires integration with media encoding, server and decoding in order to provide a proper end-to-end protection level. The interfaces for the various exemplary media platforms are discussed below.

The digital rights network 39 utilizes Windows Media DRM for encryption of Windows Media content and the Real DRM for encryption of Real content.

The digital rights network 39 may also implements a number of internal interfaces, examples of which are provided below:

Digital Rights Agent <> LDAP Server Interface:

A digital rights agent 28 may utilize standard LDAP to interface with an LDAP server.

Digital Rights Agent <> Content/User Server Interface:

A digital rights agent 28 may utilize standard HTTP to interface with the content and user servers 120 and 122. To access internal data tables, the following URL is used:
http://<server>/scripts/data.dll/<queryId>[<search>]

For example, to create a new user entry for CRM operator Net36:
http://user.net36.sentriq.net/scripts/data.dll?QueryId=User&CrmId=Net36&AccountId=piet@home&UserId=0

The content of the HTTP request message contains the actual user data (XML).

Another example to query user information:
http://user.net36.sentriq.net/scripts/data.dll?Q_ofser&CrmId=Net36&AccountId=piet@home&UserId=0&NetworkId=4&AgentId=3

The content of the HTTP response message contains the actual user data (XML). The network ID and agent ID are recorded by a data server. This enables asynchronous notification of the corresponding digital rights agent 28 in case the user data is updated.

Data Model

A description follows of exemplary tables of the may be maintained within databases of the content and user servers 120 and 122 of the digital rights network 39. The exemplary tables contain a generic XML structure to hold the actual fields.

Account

CrmId: String(10)
AccountId: String(30)
Timestamp: DateTime
Data: XML (name, email, billing information)
   Index: CrmId+AccountId
   User
CrmId: String(10)
AccountId: String(30)
UserId: String(30)
Timestamp: DateTime
Data: XML (Debit, credit, name, URL, PIN, email, language, nationality, dateOfBirth, entitlements, etc)
   Index: CrmId+AccountId+UserId
   History
CrmId: String(10)
AccountId: String(30)
UserId: String(30)
Timestamp: DateTime
Data: XML
   Index (not unique): CrmId+AccountId+UserId
   Content
CrmId: String(10)
AccountId: String(30)
ItemId: String(30)
Description: String(30)
Type: String(7)
PolicyId: String(30)
Timestamp: DateTime
Data: XML
   Index: CrmId+AccountId+ItemId
   Statistics
CrmId: String(10)
AccountId: String(30)
ItemId: String(30)
UserCrmId: String(10)
Timestamp: DateTime
Hits: Int
TotalHits: Int
Data: XML
   Index: CrmId+AccountId+ItemId+UserCrmId
   Secondary index: CrmId+AccountId+Timestamp
   Query: Get rows for Crmd=CRMID and Account=ACCID and Timestamp>BEGIN, sorted by Hits
   Policy
CrmId: String(10)
AccountId: String(30)
Type: String(7)
PolicyId: String(30)
Name: String(30)
Timestamp: DateTime
Data: XML
   Index: CrmId+AccountId+Type+PolicyId
   CrmPolicy
CrmId: String(10)
AccountId: String(30)
PolicyId: String(30)
UserCrmId: String(30)
Timestamp: DateTime
Data: XML
   Index: CrmId+AccountId+PolicyId+UserCrmId
   Roaming
CrmId: String(10) [default ‘0’=all CRM's]
AccountId: String(30) [default ‘0’=all CRM accounts]
UserCrmId: String(30)
   Index: CrmId+AccountId+UserCrmId
   Resource
CrmId: String(10)
AccountId: String(30) [default ‘0’=all CRM accounts]
ResourceId: String(30)
Data: XML
   Index: CrmId+AccountId+ResourceId

### EXAMPLE

### Resource to Control Forward URL for Content or User Statistics for a Certain CRM

The exemplary database provides queries for accessing all tables through the primary and secondary indexes. A number of additional queries to enable GUI lookups:
UserList: List of users for a certain crmId, accountId, including userId and NickName fields.
PolicyList: List of all policies for a certain crmId, accountId, including policyId and description.

A LDAP server is used to map a user authentication ID to an entry in the user rights database. The following fields are added specifically for queues within the digital rights network 39:
sentriquser: cid=<CRM id>,aid=<account ID>,uid=<user ID>
   For example:
sentriquser: cid=Sentriq,aid=rfrans@home.com,uid=0
   There may be multiple entries per authentication ID/user.
sentriqdevice: did=<device ID>,dkey=<device KEY>
   For example:
sentriqdevice: did=92745672,dkey=7F98EA826BB490EC
   Computer System

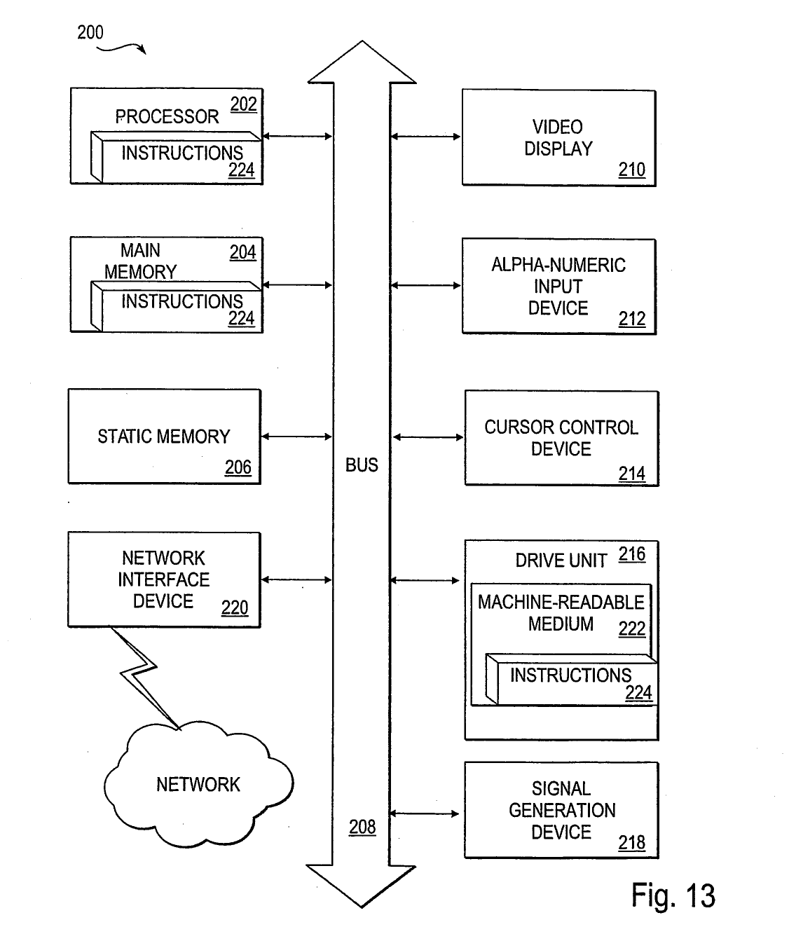

FIG. 13 is a diagrammatic representation of a machine in the form of computer system 200 within which software, in the form of a series of machine-readable instructions, for performing any one of the methods discussed above may be executed. The computer system 200 includes a processor 202, a main memory 204 and a static memory 206, which communicate via a bus 208. The computer system 200 is further shown to include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device. 218 (e.g., a speaker) and a network interface device 220. The disk drive unit 216 accommodates a machine-readable medium 222 on which software 224 embodying any one of the methods described above is stored. The software 224 is shown to also reside, completely or at least partially, within the main memory 204 and/or within the processor 202. The software 224 may furthermore be transmitted or received by the network interface device 220. For the purposes of the present specification, the term “machine-readable medium” shall be taken to include any medium that is capable of storing or encoding a sequence of instructions for execution by a machine, such as the computer system 200, and that causes the machine to perform the methods of the present invention. The term “machine-readable medium” shall be taken to include, but not be limited to, solid-state memories, optical and magnetic disks, and carrier wave signals.

If written in a programming language conforming to a recognized standard, the software 224 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 200, to perform an action or a produce a result.

Thus, a distributed digital rights network, and methods of accessing, operating and implementing the same, has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A digital rights network including:
a digital rights server to store content consumer rights, defining access rights of a content consumer with respect to content, and content owner rights defining access policies to the content as established by a content owner; and
a digital rights agent to perform cryptographic operations with respect to access operations relating to the content consumer rights and the content owner rights,
wherein the access operations include a first access operation with respect to the content consumer rights and a second access operation with respect to the content owner rights.

2. The digital rights network of claim 1 the access operations relating to the content consumer rights and the content owner rights are performed by any one of a plurality of users of the digital rights network.

3. The digital rights network of claim 1 wherein the plurality of users of the digital rights network include the content owner, a commerce service provider, a content distributor and the content consumer.

4. The digital rights network of claim 1 wherein the commerce service provider comprises a customer relationship management (CRM) operator.

5. The digital rights network of claim 1 including a plurality of digital rights agents, and wherein the access operations are performed through at least one of the plurality of digital rights agents.

6. The digital rights network of claim 5 the plurality of digital rights agents is distributed across a communications network.

7. The digital rights network of claim 1 wherein the first access operation is performed by a content distributor with which the content consumer has a relationship.

8. The digital rights network of claim 1 wherein the first access operation is performed by a commerce service provider with which the content consumer has a relationship.

9. The digital rights network of claim 1 wherein the second access operation is performed by the content owner.

10. The digital rights network of claim 1 wherein the access operations include any one of a rights query, a rights update, a rights registration, a rights de-registration and a rights exercise operation.

11. The digital rights network of claim 1 wherein both the first and the second access operations are performed through the digital rights agent.

12. The digital rights network of claim 1 wherein the cryptographic operations include any one of identity authentication, license creation, data encryption, data description, signature generation and signature verification.

13. The digital rights network of claim 12 wherein the identity authentication is performed utilizing any one of a digital signature, username/password and TLS/SSL-based authentication.

14. The digital rights network of claim 1 including a distributed set of the digital rights servers to store the content consumer rights and the content owner rights.

15. The digital rights network of claim 1 wherein the digital rights server is to store and retrieve the content consumer rights and the content owner rights, and the digital rights agent is to enforce the content consumer rights and the content owner rights.

16. The digital rights network of claim 1 wherein the content consumer rights are acquired from a content distributor with which the content consumer has a relationship.

17. The digital rights network of claim 1 wherein the content consumer rights are acquired from a plurality of network operators.

18. The digital rights network of claim 1 wherein a certificate is associated with the content consumer, and wherein the content consumer rights, acquired from the plurality of network operators, are attributed to the content consumer utilizing the certificate.

19. The digital rights network of claim 1 wherein the first access operation is to register the content consumer and is performed by a network operator, the digital rights agent to verify that the network operator is authorized to perform the first access operation.

20. The digital rights network of claim 1 wherein the first access operation is to register the content consumer rights, and the digital rights agent is to encrypt and sign the content consumer rights prior to storage thereof by the digital rights server.

21. The digital rights network of claim 1 wherein the first access operation is by the content consumer and is to create a license to the content, wherein the digital rights agent is to create the license.

22. The digital rights network of claim 1 wherein the first access operation is by the content consumer to validate access to the content, and the digital rights agent is to perform the validating action.

23. The digital rights network of claim 1 wherein the digital rights server comprises a content server to store the content owner rights and a user server to store the content consumer rights.

24. A method of operating a digital rights network, the method including:
storing content consumer rights, defining access rights of a content consumer with respect to content, and content owner rights defining access policies to the content as established by a content owner at the digital rights server; and
performing cryptographic operations, utilizing a digital rights agent, with respect to access operations relating to the content consumer rights and the content owner rights,
wherein the access operations include a first access operation with respect to the content consumer rights and a second access operation with respect to the content owner rights.

25. The method of claim 24 the access operations relating to the content consumer rights and the content owner rights are performed by any one of a plurality of users of the digital rights network.

26. The method of claim 24 wherein the plurality of users of the digital rights network include the content owner, a commerce service provider, a content distributor and the content consumer.

27. The method of claim 24 wherein the commerce service provider comprises a customer relationship management (CRM) operator.

28. The method of claim 24 wherein the digital rights agent is one of a plurality of digital rights agents, the method including directing all access operations with respect to the content owner rights and the content consumer rights to be performed through at least one of the plurality of digital rights agents.

29. The method of claim 28 including distributing the plurality of digital rights agents across a communications network.

30. The method of claim 24 wherein the first access operation is performed by a content distributor with which the content consumer has a relationship.

31. The method of claim 24 wherein the first access operation is performed by a commerce service provider with which the content consumer has a relationship.

32. The method of claim 24 wherein the second access operation is performed by the content owner.

33. The method of claim 24 wherein the access operations include any one of a rights query, a rights update, a rights registration, a rights de-registration and a rights exercise operation.

34. The method of claim 24 wherein both the first and the second access operations are performed through the digital rights agent.

35. The method of claim 24 wherein the cryptographic operations include any one of identity authentication, license creation, data encryption, data description, signature generation and signature verification.

36. The method of claim 35 wherein the identity authentication is performed utilizing any one of a digital signature, username/password and TLS/SSL-based authentication.

37. The method of claim 24 including a distributed set of the digital rights servers to store the content consumer rights and the content owner rights.

38. The method of claim 24 including storing and retrieving the content consumer rights and the content owner rights utilizing the digital rights server, and enforcing the content consumer rights and the content owner rights utilizing the digital rights agent.

39. The method of claim 24 wherein the content consumer rights are acquired from a content distributor with which the content consumer has a relationship.

40. The method of claim 24 wherein the content consumer rights are acquired from a plurality of network operators.

41. The method of claim 24 wherein a certificate is associated with the content consumer, the method including attributing the content consumer rights, acquired from the plurality of network operators, to the content consumer utilizing the certificate.

42. The method of claim 24 wherein the first access operation is to register the content consumer and is performed by a network operator, the method including verify that the network operator is authorized to perform the first access operation utilizing the digital rights agent.

43. The method of claim 24 wherein the first access operation is to register the content consumer rights, the method including encrypt and signing the content consumer rights, utilizing the digital rights agent, prior to storage thereof by the digital rights server.

44. The method of claim 24 wherein the first access operation is by the content consumer and is to create a license to the content, the method including creating the license utilizing the digital rights agent.

45. The method of claim 24 wherein the first access operation is by the content consumer to validate access to the content, the method including performing a validating action utilizing the digital rights agent.

46. The method of claim 24 wherein the digital rights server comprises a content server to store the content owner rights and a user server to store the content consumer rights.

47. A digital rights network including:
first means for storing content consumer rights, defining access rights of a content consumer with respect to content, and content owner rights defining access policies to the content as established by a content owner; and
second means for performing cryptographic operations with respect to access operations relating to the content consumer rights and the content owner rights,
wherein the access operations include a first access operation with respect to the content consumer rights and a second access operation with respect to the content owner rights

48. A machine-readable medium storing a sequence of instructions that, when executed by a machine, cause machine to perform a method of operating a digital rights network, the method including:
storing content consumer rights, defining access rights of a content consumer with respect to content, and content owner rights defining access policies to the content as established by a content owner at the digital rights server; and
performing cryptographic operations, utilizing a digital rights agent, with respect to access operations relating to the content consumer rights and the content owner rights,
wherein the access operations include a first access operation with respect to the content consumer rights and a second access operation with respect to the content owner rights.
